(19) United States
(12) Patent Application Publication
(10) Pub. No.: US 2025/0353282 A1
(43) Pub. Date: Nov. 20, 2025

(54) METHOD FOR PRODUCING A VEHICLE COMPOSITE PANE WITH IMPROVED IMPACT PROTECTION

(71) Applicant: SAINT-GOBAIN GLASS FRANCE, COURBEVOIE (FR)

(72) Inventors: Emmanuel WALCH, HERZOGENRATH (DE); Alessandro BENEDETTO, HERZOGENRATH (DE); René GY, HERZOGENRATH (DE); Bernard NGHIEM, HERZOGENRATH (DE)

(21) Appl. No.: 18/880,011

(22) PCT Filed: Jun. 21, 2023
(86) PCT No.: PCT/EP2023/066824

§ 371 Date: Dec. 30, 2024

(30) Foreign Application Priority Data
Jun. 29, 2022 (EP) 22181828.9

(51) Int. Cl. B32B 17/10; B32B 3/30

(52) U.S. Cl. CPC B32B 17/10146; B32B 3/30; B32B 17/10036; B32B 17/1077; B32B 17/10788; B32B 17/10889; B32B 17/10935; B32B 2250/03; B32B 2307/536; B32B 2307/7376; B32B 2605/08

(57) ABSTRACT

A method for producing a vehicle composite pane with improved impact protection, wherein at least a) an outer pane and an inner pane are provided, b) in at least a first partial region defect areas are introduced into the outer pane and/or inner pane, c) the outer pane and the inner pane are bent congruently together, d) a thermoplastic intermediate layer is placed onto the outer pane or the inner pane, e) the layer stack is completed with the inner pane or outer pane, and f) the layer stack composed of at least the outer pane, thermoplastic intermediate layer and inner pane is laminated to form a windshield, wherein the defect areas are introduced into the outer pane and/or inner pane by means of indentation.

The invention relates to a method for producing a vehicle composite pane with improved impact protection, to such a vehicle composite pane and to its use.

Composite panes, which comprise at least two panes and at least one polymer film adhesively bonded between the panes, have been used for decades in large quantities in various technical fields, in particular in building glazing and in vehicle construction. The selection of the materials used and the dimensioning of the components takes place as a function of the requirements of the specific intended purpose, in particular with regard to the desired mechanical load-bearing capacity of the finished glazing, taking into account the boundary conditions set by the framing and any attachments.

U.S. Pat. No. 3,437,552 A discloses composite panes comprising two glass panes and an intermediate polyvinyl butyral (PVB) layer.

U.S. Pat. No. 6,708,595 B1 discloses an armored composite glass pane for motor vehicles, which comprises a stack sequence of a plurality of panes and a plurality of adhesive intermediate layers between them.

JP 2008133141 A discloses a composite pane comprising an intermediate layer, wherein the intermediate layer has a first region and a second region and the tensile stiffness of the intermediate layer is higher in the first region than in the second region.

In the automotive industry in particular, there is a trend towards the use of thinner and therefore lighter glass in composite glass panes as part of efforts to reduce weight and thus achieve fuel and electricity savings. Nevertheless, such glazings must meet defined mechanical requirements that are fixed in relevant industrial standards. In this context, safety requirements increase not only for vehicle occupants but also for other road users, such as pedestrians. For example, in the event of a head-on collision between a pedestrian and a car, the pedestrian is very likely to hit the hood of the car, causing their head to hit the windshield of the car. This can result in severe or even fatal injury to the pedestrian, in particular if their head smashes through the windshield and hits other objects, such as the dashboard. In other accident scenarios as well in which an object hits the windshield, it is desirable to specifically control the fracture characteristics of the windshield and thereby ensure improved impact protection in certain regions of the windshield. Which regions of the windshield should be equipped with improved impact protection should be freely selectable depending on the customer's wishes, the pane model and the most likely accident scenario.

The invention is therefore based on the object of providing a method for producing a vehicle composite pane with controllable fracture characteristics and associated improved impact protection, as well as a composite pane having said properties. In particular when used as a windshield, the composite pane should, on the one hand, offer greater accident safety for pedestrians and, on the other hand, ensure compliance with the relevant standards for windshields concerning stone impact resistance and transparency.

According to the proposal of the invention, this object is achieved by a method according to claim 1. Advantageous embodiments of the invention emerge from the dependent claims.

The method according to the invention for producing a windshield with improved impact protection comprises at least the steps of:
) a) providing an outer pane and an inner pane,
b) introducing defect areas in at least a first partial region of the outer pane and/or inner pane,
c) bending the outer pane with defect areas and/or bending the inner pane with defect areas,
d) placing a thermoplastic intermediate layer onto the outer pane or the inner pane,
e) completing the layer stack of at least the outer pane and the thermoplastic intermediate layer with the inner pane, or completing the layer stack of at least the outer pane and the thermoplastic intermediate layer with the outer pane, and
f) laminating the layer stack composed of at least the outer pane, thermoplastic intermediate layer and inner pane to form a windshield,
wherein the defect areas in step b) are introduced into the outer pane and/or inner pane by means of indentation, and the inner pane and the outer pane are glass panes.

The inventors have found that a vehicle composite pane produced using the method according to the invention has improved fracture characteristics in the first partial region when an object hits the windshield. The defect areas introduced by indentation lead to a targeted weakening of the outer pane and/or inner pane, which significantly influences the fracture characteristics of the vehicle composite pane in the first partial region and as a result of which an impacting body experiences a lower deceleration rate. In the method according to the invention, the defect areas are first introduced by indentation and the panes are then bent. The inventors have found that indentation of one or both panes of the vehicle composite pane prior to bending results in a composite pane with the desired improved fracture characteristics while maintaining the stone impact resistance of the vehicle pane. In this context, improved fracture characteristics mean that an early fracture of the pane occurs in the first partial region(s) of the composite pane. The location and size of the first partial region(s) can be freely selected depending on the application. Improved fracture characteristics are advantageous, for example, in regions of the windshield where the pedestrian's head is likely to be impacted in accidents involving pedestrians. Heating of the indented pane(s) during the bending process causes a partial healing of the defect areas created by indentation, which has a beneficial effect on the mechanical properties of the pane. Moreover, in practice it is much easier to indent non-curved planar panes than to machine the curved panes.

In a preferred embodiment of the method according to the invention, the defect areas are provided on the interior-side surface of the outer pane and/or on the interior-side surface of the inner pane. These pane surfaces are subject to the greatest deflection when an object hits the outside surface of the outer pane. In order to achieve early breakage of the composite pane produced in the method according to the invention in at least a first partial region, for example in case of human head impact, it is advantageous to introduce the defect areas on the pane surfaces mentioned.

The defect areas introduced in the method according to the invention can be spherical, rectangular, rhombic, pyramidal or conical. The geometry of the defect area is determined by the geometry of the indenter tip used. Methods for microindentation or nanoindentation are generally known to those skilled in the art and are generally used to test the hardness of materials. Preferably, indentation in the method according to the invention is carried out as microindentation or nanoindentation, wherein the indenter tip has a spherical, rectangular, rhombic, pyramidal or conical geometry. Corresponding indenter tips are commercially available and known to those skilled in the art. Over time, a wide variety of methods for testing the hardness of materials has been established, wherein they differ primarily in terms of their area of application within different material groups and in terms of the geometry of the indenter tip.

The defect areas are preferably introduced by indentation with an indenter tip for hardness testing according to Brinell (DIN EN ISO 6506-1 to EN ISO 6506-4), Vickers (DIN EN ISO 6507-1:2018 to-4:2018), Knoop (DIN EN ISO 4545-1 to-4), Rockwell (DIN EN ISO 6508-1) or with an indenter tip having the basic shape of a triangular pyramid according to Berkovich. The hardness test according to Brinell uses a hard metal ball as indenter tip, wherein the balls used can have a diameter of 1 mm, 2.5 mm, 5 mm or 10 mm. An indenter tip for hardness testing according to Vickers is designed as an equilateral diamond pyramid with an opening angle (measured between the side surfaces, not the edges of the pyramid) of 136°. The hardness test according to Knoop is based on Vickers' hardness test, but unlike the latter uses a diamond tip having a rhombic shape with tip angles of 172.5° for the long side and 130° for the short side of the indenter tip. The hardness test according to Rockwell uses different tip geometries of the indenter tip, for example steel balls or conical diamond tips are used as test specimens. An indenter tip according to Berkovich has the basic shape of a triangular pyramid and is described in detail, for example, in Determination of fracture toughness of brittle materials by indentation (Acta Mechanica Solida Sinica, Vol. 28, No. 3, June 2015). All aforementioned indenter tips are commercially available and are specified in more detail in the cited standards.

The defect areas are preferably introduced by indentation with an indenter tip for hardness testing according to Vickers or according to Berkovich with an indentation load of 50 g to 700 g, particularly preferably 100 g to 600 g, in particular 200 g to 550 g.

In a preferred embodiment of the method, the indenter tip is first positioned above the surface to be indented. The indenter tip is held in the air by a force sensor and then lowered onto the glass surface. When the indenter tip is no longer supported by the sensor, it indents the glass with a load that corresponds to the mass of the indenter tip components plus an optional additional load. Preferably, an indenter tip is used which has a mass of 250 g, which results in a corresponding indentation load which can be further increased if necessary, for example to 500 g. Tests by the inventors have shown that indentation with an indenter tip for hardness testing according to Vickers with an indentation load of 250 g or 500 g or a weight between 250 g and 500 g is particularly advantageous in order to achieve advantageous fracture behaviour with good stone impact resistance of the composite pane. The indentation load used can also vary depending on the position of the defect area on the pane surface. This means that it is possible to create larger defect areas in the glass surface in some places and smaller defect areas in others. By correlating the size of the defect area with the indentation load, the fracture behaviour of the pane can be controlled in general and also specifically depending on the position of the defect area on the pane. Regions where the pane is supposed to break earlier are provided with larger defect areas which are created by means of a higher indentation load, while regions with smaller defect areas will break at a later point in time.

Composite panes for vehicle glazing are usually produced by laminating two curved flat glass panes. The float process is the most common and economically advantageous method for producing flat glass, so that panes for vehicle glazing are usually produced using this manufacturing method. Depending on the defects already caused by the manufacturing method, indentation after the panes have been manufactured can be adapted, wherein the surface compressive stress of the panes after indentation is preferably between 50 MPa and 100 MPa.

In a preferred embodiment of the method according to the invention, indentation in step b) is carried out by means of several indenter tips which contact the surface to be indented at least partially simultaneously. At least partially simultaneously means that at least two indenter tips touch the surface to be indented in the same time window or in two partially overlapping time windows. Particularly preferably, several indenter tips are mounted on a holder, for example a frame, and are simultaneously lowered onto the surface to be indented. This results in easy handling and time-efficient processing times. Preferably, the number and position of indenter tips attached to a common holder corresponds to the number and position of defect areas to be introduced into a glass surface. Therefore, the holder with indenter tips needs to be positioned only once for each workpiece, wherein all defect areas can be introduced simultaneously. The indentation load can be set to be different for each indenter tip or to be the same for several or all indenter tips. A different indentation load is advantageous in order to adapt the size of the defect areas depending on the position of the defect area on the pane. If defect areas of different sizes are desired within a workpiece, different indentation loads can be applied between the respective indenter tip and the holder that supports the indenter tips. Also, if the same indentation load is desired for all indenter tips, one or more loads can be applied to the holder itself.

In step c) of the method according to the invention, at least the pane or panes into which defect areas have been introduced are bent. The outer pane and/or the inner pane are preferably bent at a temperature of 500° C. to 700° C.

The outer pane and the inner pane can be bent individually. Preferably, the outer pane and the inner pane are curved together congruently (i.e., simultaneously and by the same tool) because this optimally matches the shape of the panes to one another for the subsequent lamination.

In one possible embodiment of the invention, defect areas are introduced only into the outer pane while the inner pane is not pre-bent. A thin inner pane is used which has a film-like flexibility and can thus be adapted to the pre-bent outer pane without having to be pre-bent itself. This simplifies the production of composite glass. In a preferred embodiment, the inner pane is also subjected to a bending process. This is in particular advantageous in the case of strong curves in multiple spatial directions (so-called “three-dimensional bending”).

If coatings, such as solar control coatings or heatable coatings, are to be applied to the surfaces of the outer pane and inner pane facing the thermoplastic intermediate layer, the panes are preferably connected to form the laminated glass after the coating has been applied. If the vehicle composite pane comprises coatings that are to be electrically contacted, the electrically conductive layers are electrically contacted via busbars or other suitable electrical conductors before the composite pane is laminated.

Any opaque cover prints applied to the edge of the composite pane are preferably applied using the screen printing method.

The outer pane and inner pane are connected via the thermoplastic intermediate layer to form the vehicle composite pane, preferably by lamination under the effect of heat, vacuum and/or pressure. Methods known per se for producing a laminated pane can be used. During lamination, the heated, flowable thermoplastic material flows, so that a stable bond is produced.

For example, so-called autoclave methods can be carried out at an elevated pressure of approximately 10 bar to 15 bar and at temperatures of 130° C. to 145° C. for approximately 2 hours. Vacuum bag or vacuum ring methods known per se operate, for example, at approximately 200 mbar and 80° C. to 110° C. The outer pane, the thermoplastic intermediate layer, and the inner pane can also be pressed in a calender between at least one pair of rollers to form a pane. Systems of this type are known for producing panes and normally have at least one heating tunnel upstream of a pressing unit. The temperature during pressing is, for example, from 40° C. to 150° C. Combinations of calender and autoclave methods have proven particularly successful in practice. Vacuum laminators can be used as an alternative. These consist of one or more heatable and evacuable chambers, in which the panes are laminated within, for example, approximately 60 minutes at reduced pressures of 0.01 mbar to 800 mbar and temperatures from 80° C. to 170° C.

The invention further relates to a vehicle composite pane comprising at least an outer pane made of glass with an outer surface I and an interior-side surface II and an inner pane made of glass with an outer surface III and an interior-side surface IV, wherein the interior-side surface II of the outer pane and the outer surface III of the inner pane are connected to one another via a thermoplastic intermediate layer. The vehicle composite pane comprises, in at least a first partial region, defect areas which are introduced into the outer pane and/or inner pane, wherein the defect areas are introduced by means of indentation.

The defect areas introduced by indentation reduce the strength of the glass. The inventors have made use of this generally undesirable effect to influence the fracture characteristics of the composite pane. In this way, early fracture of the pane can be induced in regions with defect areas, while fracture of the pane occurs with a delay or does not occur at all in regions without defects. The regions in which early window fracture is expedient can vary depending on the accident scenario, the consequences of which are to be mitigated. The targeted weakening of the outer pane and/or inner pane of the composite pane leads to early fracture in the event of a body impact. After one or both of the glass panes break, a considerable amount of energy is absorbed due to the expansion of the thermoplastic intermediate layer and the at least partial delamination in the region of the broken glass panes. The thermoplastic intermediate layer is expandable and therefore yields, so that a colliding body is slowed down less abruptly and experiences a lower deceleration rate. The vehicle composite pane according to the invention is used, for example, to mitigate the impact of a human head on the windshield in accidents involving pedestrians. An abrupt deceleration of the head, as occurs in the case of a late glass fracture, should be avoided. A composite pane not according to the invention without defect areas shows a late glass fracture in the event of a head impact, wherein a large part of the kinetic energy of the impact is dissipated by the bending of the glass, which leads to a high deceleration rate of the head. To quantify this head impact, the Head Injury Criterion (HIC) is used for example, which assesses the severity of an impact based on the deceleration rate of the head. High deceleration rates are usually associated with high HIC values, which are associated with severe injuries to the head of the pedestrian. A low HIC value is equivalent to a low risk for severe head injuries.

The strength is lower in regions where the defect areas have been deliberately introduced. As a rule, a glass breakage always begins at a defect in the glass if tensile stress is exerted in this region. Minor statistically distributed defects can be detected in glass panes due to the production process. However, their influence on the breaking behavior is not predictable, due to the statistical distribution of such natural defects. In contrast to random defects in the glass, the defect areas introduced according to the invention in the first partial region of the composite pane can be specifically placed in the first partial region of the windshield, this being the region in which early fracture is supposed to occur. As a result, the composite pane according to the invention also offers greater safety for a passer-by, for example, in the event of a traffic accident involving the passer-by, since the severity of the impact of the human head in the event of a head-on collision is mitigated by early fracture of the composite pane.

Preferably, the vehicle composite pane according to the invention is produced by means of the method according to the invention.

The vehicle composite pane is provided for separating a vehicle interior from an external environment. The vehicle composite pane is therefore a window pane that is inserted into a window opening in the vehicle body or is provided for this purpose. A first pane of the vehicle composite pane is the outer pane of the vehicle composite pane, which faces the external vehicle surroundings, while the second pane of the vehicle composite pane is the inner pane, which is oriented to the vehicle interior. It is understood that the first pane, the second pane and the thermoplastic intermediate layer have substantially the same outer dimensions. The surface of the relevant pane which faces the external surroundings of the vehicle when installed is referred to as the outer surface. The surface of the respective pane that faces the interior of the vehicle in the installed position is referred to as the interior-side surface. The interior-side surface of the outer pane is connected to the outer surface of the inner pane via the thermoplastic intermediate layer. The outer surface of the outer pane is usually referred to as “side I”, the interior-side surface of the outer pane as “side II”, the outer surface of the inner pane as “side III”, and the interior-side surface of the inner pane as “side IV”.

The vehicle composite pane according to the invention has a first surface region, referred to as the first partial region. This first partial region comprises at least a portion of the surface area of the vehicle composite pane, but can also comprise the entire pane surface of the vehicle composite pane. If the first partial region covers less than the entire pane surface of the vehicle composite pane, the surface region not covered by the first partial region is referred to as the second partial region of the vehicle composite pane. The second partial region comprises regions in which no defect areas produced by indentation are present. A plurality of first partial regions and/or second partial regions can also be present, wherein the first partial regions comprise defect areas, while the second partial regions are free of defect areas. In a preferred embodiment, the vehicle composite pane has only a first partial region and a second partial region, which together cover the total area of the vehicle composite pane.

The thermoplastic intermediate layer can comprise one or more other films. These can be, for example, films that have electrically switchable functions or colored regions. The thermoplastic intermediate layer can have a single-layer or multi-layer structure. In one possible embodiment, the thermoplastic intermediate layer is designed as a film laminate, for example as a film laminate having three layers.

The defect areas produced by indentation are applied to the outer pane and/or inner pane. As a result, one or both panes of the vehicle composite pane are weakened in a targeted manner in order to bring about early fracture. The severity of the impact is reduced by the early breaking of the vehicle composite pane. After the glass breaks, a considerable amount of energy is absorbed due to the expansion of the thermoplastic intermediate layer and the partial delamination of the broken glass fragments. Due to the stretching of the thermoplastic intermediate layer, the human head is exposed to a lower deceleration rate. Very abrupt head decelerations, such as those that occur in case of late glass fracture, are thus avoided. The defect areas are preferably introduced in the interior-side surface of the outer pane and/or the interior-side surface of the inner pane. Composite pane fracture is not caused directly by the impact of an object on the outer side of the composite pane, but by the tensile stress that occurs in the glass, particularly on the interior-side surfaces of the outer pane and the inner pane. This is the case in particular with semi-hard objects, such as a human head. The composite pane first breaks at the points at which the tensile stress is greatest. If an impact occurs on the outer surface of the outer pane, the greatest tensile stresses arise on the interior-side surface of the outer pane and on the interior-side surface of the inner pane. If the defect areas are applied to one of these surfaces, the desired early fracture occurs there. Particularly preferably, the defect areas are applied at least to the interior-side surface of the inner pane. The highest tensile stresses occur on this surface.

The diameter of the defect areas is preferably 10 μm to 500 μm, particularly preferably 15 μm to 250 μm. The diameter of a defect area is determined as the maximum diameter of the defect area, i.e. the maximum measurable extent of the defect area. This made it possible to achieve reliable fracture of the pane, while at the same time keeping the indentation surface small in order to save costs and avoid visual impairments. The diameter of the defect areas is measured as the total diameter of the visible defect caused by indentation. It consists of the imprint of the indenter tip visible in the glass surface and any other adjacent damage, such as cracks originating from the imprint of the indenter tip.

If the defect areas are created using a Vickers tip as indenter tip, the length of the diagonals of the tip impression is preferably between 10 μm and 500 μm. Tip impressions with a diameter of 15 μm to 250 μm, especially 20 μm to 40 μm, have proven to be particularly preferred. Defect areas with tip imprints of this size are visually very inconspicuous for the driver of the vehicle and, in tests by the inventors, lead to the desired early fracture of the pane while, at the same time, providing sufficient stone impact resistance.

Preferably, the defect areas form a regular or irregular pattern within the first partial region of the composite pane, wherein defect areas adjacent to one another within one plane have an average distance from 1 cm to 50 cm, preferably from 2 cm to 30 cm, particularly preferably from 3 cm to 15 cm, for example from 5 25 cm to 10 cm. This has proven to be advantageous so that a head hitting the composite pane always strikes near a defect area in the first partial region.

Preferably, the first partial region in which defect areas are introduced takes up between 10% and 100%, preferably 20% to 90%, particularly preferably 30% to 70%, of the total area of the composite pane. Tests have shown that the mentioned preferred surface portions of the first partial region are sufficient to achieve good safety.

In a preferred embodiment, the vehicle composite pane according to the invention is a windshield. The peripheral edge of the composite pane has four portions that, in relation to the installation location of the windshield in a motor vehicle, are referred to as the engine edge, roof edge and side edges, wherein two opposing side edges connect the engine edge and the roof edge. The windshield has at least a first partial region that extends in the direction of the roof edge adjacent to the engine edge of the windshield. The windshield has a transmission of at least 70% in the visible range of the light spectrum. In particular, in the main field of vision of the windshield, also known as the A-field, a transmission of at least 70% in the visible range is required in order to meet the legal regulations for windshields (ECE-R 43,Annex 3, Sec. 9.1 Procedure for testing the light transmittance of motor vehicle panes). If the first partial region extends into the main field of vision of the windshield, the transmission should be 70%; in other regions, a lower transmission is sufficient.

Preferably, the first partial region of the composite pane in which the defect areas are located is a region adjacent to the engine edge in which the head of a pedestrian is more likely to hit in the event of an accident.

Preferably, the first partial region extends at least in portions from the engine edge of the windshield by an amount in the direction of the roof edge of the windshield that corresponds to 10% to 90%, preferably 20% to 70% of the height of the windshield. The height of the windshield is determined by measuring the shortest distance to the roof edge at the relevant position of the engine edge. Subsequently, the amount by which the first partial region extends in the direction of the roof edge is determined at the same position of the engine edge as the shortest distance between the engine edge and the upper edge of the first partial region offset in the direction of the roof edge, as a result of which the height of the first partial region arises at this position along the engine edge. This height of the first partial region is set in relation to the height of the windshield, measured in each case at the same position along the windshield, thereby obtaining the relative amount by which the first partial region extends from the engine edge in the direction of the roof edge. The height up to which the first partial region extends is determined as a function of the vehicle geometry, wherein the region in which the head of a pedestrian would most likely hit in the event of an accident is preferably located in the first partial region. The first partial region is attached adjacent to the engine edge and extends from there, at least in portions, up to the mentioned height of the windshield. “In portions” means that the first partial region projects into the windshield in at least one portion along the engine edge of the windshield up to the specified height in the direction of the roof edge, but can also have a lower height in other portions. The upper edge of the first partial region, i.e. the edge section of the first partial region with the greatest distance from the engine edge of the windshield, preferably runs in a straight line or a curve between the side edges of the windshield.

In one possible embodiment, the density of the defect areas, i.e. the number of defect areas per unit area, decreases within the first partial region from the engine edge towards the roof edge. The density of defect areas adjacent to the upper edge of the first partial region is therefore lower than the density of defect areas adjacent to the engine edge. In this way, a gradual transition between the first partial region and an adjacent second partial region can be created without any defect areas.

In a particularly preferred embodiment, the size of the first partial region is selected such that, in the installed state of the windshield in a motor vehicle, the size of the first partial region corresponds to at least 90% of the area of the projection of the dashboard of the motor vehicle onto the windshield. Particularly preferably, the size of the first partial region corresponds to at least the area of the projection of the dashboard onto the windshield. A common accident scenario involving pedestrians is that the pedestrian's head hits the windshield in the region of the dashboard. If the windshield is broken in this region, the pedestrian's head hits the dashboard behind it directly, wherein the likelihood of severe injury is increased. In this respect, it is advantageous to design the region of the windshield which, when installed, is covered by a projection of the dashboard onto the windshield as the first partial region, as a result of which the windshield breaks at an early stage.

The edge portion of the first partial region that has the greatest distance from the engine edge along the engine edge is referred to as the upper edge of the first partial region. The edge of the first partial region is a line enclosing the first partial region with defect areas. The upper edge of the first partial region preferably extends between the side edges of the windshield, wherein the upper edge can, but does not have to, end at the side edges of the windshield. This means that the upper edge can meet the respective side edge on one or both side edges of the windshield.

In principle, the first partial region can have any shape and preferably has the shape of a rectangle or a rounded rectangle or a semicircle or a semi-ellipse, in each case adjacent to the engine edge of the windshield. Depending on the geometry of the windshield, other forms are also expedient.

In a preferred embodiment, the upper edge of the first partial region runs in a straight line between the side edges and ends at the side edges of the windshield. For a straight-line upper edge, a course horizontal in the installed state of the windshield in the vehicle has proven to be advantageous in order to achieve the desired reduction in strength in the first partial region uniformly in all regions along the engine edge. In a further preferred embodiment, the upper edge of the first partial region has a curved profile. The upper edge can end in the region of the side edges or can also run towards the corner regions and end directly in the corner region or at the portions of the engine edge adjacent to the corner region. This results in a semicircular or semi-elliptical geometry of the first partial region.

The thermoplastic intermediate layer preferably comprises polyvinyl butyral (PVB), polyurethane (PU), ionomers and/or ethylene vinyl acetate (EVA), particularly preferably PVB. These materials have proven to be particularly suitable with regard to a secure connection of the panes to one another.

The thickness of the thermoplastic intermediate layer is preferably between 300 μm and 1000 μm, particularly preferably between 500 μm and 900 μm, in particular between 650 μm and 850 μm.

The outer pane and the inner pane are made of glass, preferably soda-lime glass, as is customary for window panes. However, the panes can also be manufactured from other types of glass, for example quartz glass, borosilicate glass or aluminosilicate glass.

Independently of one another, the outer pane and the inner pane can be made of non-prestressed, partially prestressed or prestressed glass. If the outer pane and/or the inner pane are to be prestressed, this can be a thermal or chemical prestressing.

The outer pane and the inner pane in each case preferably have a thickness of 0.8 mm to 2.5 mm, particularly preferably from 1.2 mm to 2.2 mm. The thickness of the outer pane is typically between 1.0 mm and 2.5 mm. The thickness of the inner pane is preferably between 0.8 mm and 2.1 mm. The thickness of the outer pane is preferably greater than the thickness of the inner pane. For example, the outer pane can be 2.1 mm thick and the inner pane 1.1 mm thick, or the outer pane 1.8 mm thick and the inner pane 1.4 mm thick, or the outer pane 1.6 mm thick and the inner pane 1.1 mm thick, or the outer pane 1.6 mm thick and the inner pane 0.7 mm thick, or the outer pane 1.4 mm thick and the inner pane 1.1 mm thick.

The inner pane, the outer pane and the thermoplastic intermediate layer can be clear and colorless, but can also be tinted or colored. The tinting of the outer pane, inner pane and of the thermoplastic intermediate layer is selected as a function of the desired application of the composite pane. For windshields, high transmission in the visible range of the light spectrum is desired and dark tinting of the components is omitted. In one embodiment of the windshield for a motor vehicle, the total transmission through the windshield is greater than 70%, based on light type A. The term “total transmission” relates to the method defined by ECE-R 43,Annex 3, Section 9.1 for testing the light transmission of motor vehicle panes.

The vehicle composite pane according to the invention is curved in one or preferably more spatial directions, as is common for panes of motor vehicles, wherein the typical radii of curvature are in a range of approximately 10 cm to approximately 40 m.

The inner pane, the outer pane, and/or the thermoplastic intermediate layer can have further, suitable coatings known per se, e.g., anti-reflective coatings, non-stick coatings, anti-scratch coatings, photocatalytic coatings or sun protection coatings or low-e coatings.

Automotive glazings, in particular windshields, rear windows, and roof panes, usually have a peripheral cover print made of an opaque enamel, which in particular serves to protect from UV radiation and optically cover the adhesive used for installing the pane. Preferably, at least the outer pane has such an opaque peripheral cover print, particularly preferably both the outer pane and the inner pane are printed, so that the through-view from either side is prevented. The opaque cover print is applied in the form of a screen print, for example, so that this screen print circumscribes the field of view of the pane or forms its outer edge. An electrical conductor that may be arranged in the edge region of the pane and, in the case of coated panes, an optionally provided coating-free edge region are preferably covered by this cover print and are therefore optically concealed. The opaque screen print can be applied in any plane of the windshield.

The invention further comprises a vehicle comprising the composite pane according to the invention, wherein the size of the first partial region with defect areas is selected such that the size of the first partial region corresponds to at least 90% of the area of the projection of the dashboard of the motor vehicle onto the vehicle composite pane. The vehicle composite pane is the windshield of the motor vehicle. Particularly preferably, the size of the first partial region corresponds to at least the area of the projection of the dashboard onto the windshield. A common accident scenario involving pedestrians is that the pedestrian's head hits the windshield in the region of the dashboard. If the windshield is broken in this region, the pedestrian's head hits the dashboard behind it directly, wherein the likelihood of severe injury is increased. In this respect, it is advantageous to design the region of the windshield which, when installed, is covered by a projection of the dashboard onto the windshield as the first partial region, as a result of which the windshield breaks at an early stage.

All the standards mentioned relate to their version valid as on the filing date of the invention.

The various embodiments of the invention may be implemented individually or in any combinations. In particular, the features mentioned above and yet to be explained below can be used not only in the specified combinations but also in other combinations or alone without departing from the scope of the present invention. That is the case unless exemplary embodiments and/or their features are explicitly mentioned only as alternatives or are mutually exclusive. In particular, the features described in the context of the method according to the invention also apply to the composite pane, and vice versa.

The invention will be illustrated in more detail below with reference to the drawings. It should be noted that different aspects are described, each of which can be used individually or in combination. In other words, any aspect may be used with different embodiments of the invention unless explicitly presented as a pure alternative.

The drawings are purely schematic representations and are not true to scale. The drawings do not limit the invention in any way.

In the figures:

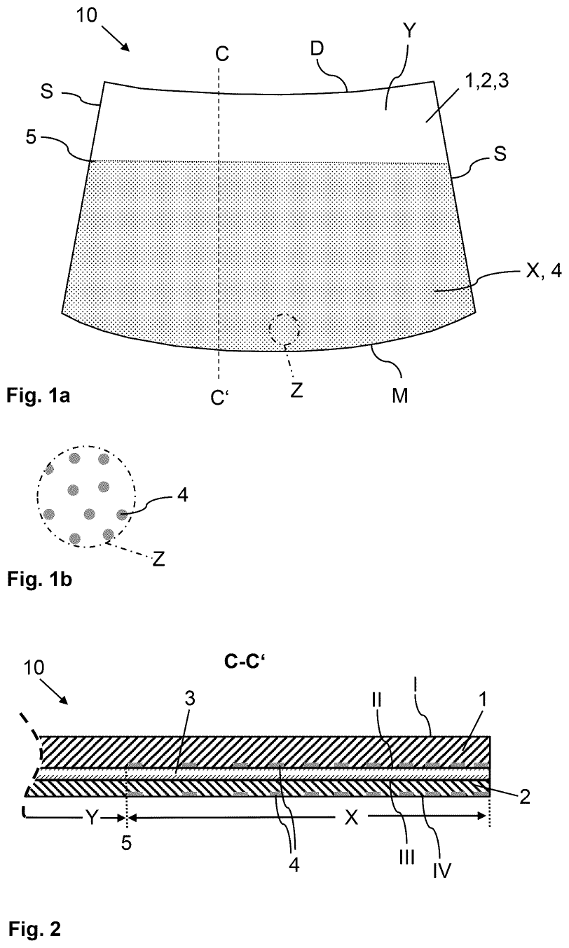

FIGS. 1a, b show a top view of an embodiment of a vehicle composite pane according to the invention as a windshield,

FIG. 2 shows a section of a cross-section through the embodiment of a vehicle composite pane as a windshield according to the invention shown in FIG. 1,

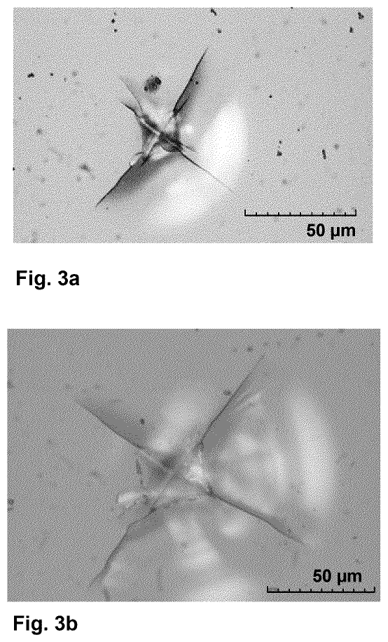

FIGS. 3a, b show samples with defect areas after indentation with a Vickers tip at different indentation loads,

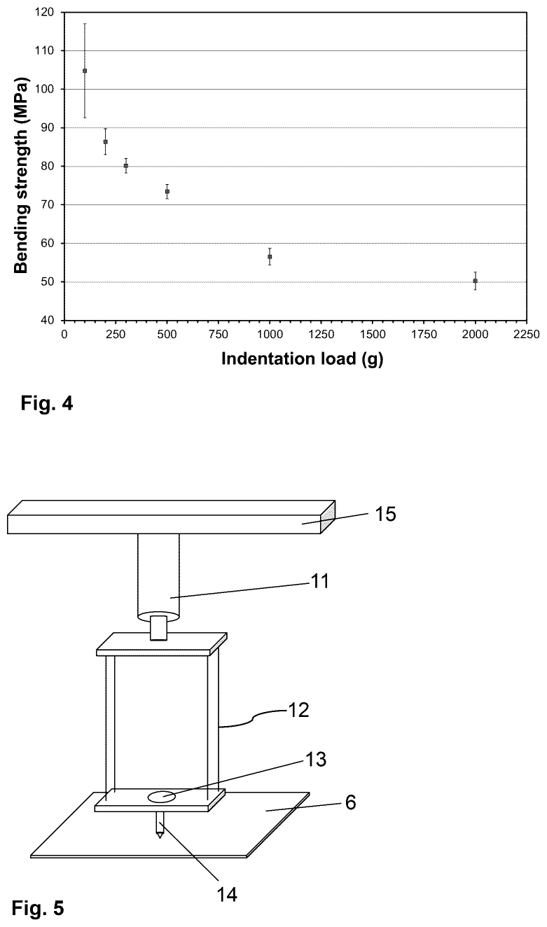

FIG. 4 shows a diagram for testing the bending strength of glasses with defect areas as a function of the indentation load, and

FIG. 5 shows a device for indentation of the samples according to FIGS. 3a, b.

FIG. 1a, b shows the top view of an embodiment of a vehicle composite pane 10 according to the invention as a windshield, while FIG. 2 shows a section of a cross-section through the embodiment shown in FIG. 1 along the section line C′-C according to FIG. 1. FIG. 1b shows an enlarged view of the region Z of the windshield of FIG. 1a.

The windshield 10 shown in FIGS. 1a, b and 2 comprises an outer pane 1 and an inner pane 2, which are connected to one another by a thermoplastic intermediate layer 3. The outer pane 1 has an outer surface I and an interior-side surface II. The inner pane 2 has an outer surface III and an interior-side surface IV. When the windshield 10 is installed, the outer surfaces I, III are oriented in the direction of the surroundings, while the interior-side surfaces II, IV are oriented toward the vehicle interior in the installed state. The interior-side surface II of the outer pane 1 is connected to the outer surface III of the inner pane 2 via the thermoplastic intermediate layer 3. The windshield 10 has a roof edge D, an engine edge M opposite the roof edge and two side edges S opposite one another, which connect the engine edge M and the roof edge D to one another. The windshield 10 has a first partial region X and a second partial region Y, wherein the first partial region X is arranged adjacent to the engine edge M.

As can be seen from FIGS. 1b and 2, defect areas 4 are arranged in the first partial region X of the windshield 10. The remaining surface region of the windshield 10 is referred to as the second partial region Y and is completely free of such defect areas 4. The outer pane 1 is, for example, a glass pane made of soda-lime glass with a thickness of 2.1 mm. The inner pane 2, for example, is made of soda-lime glass and has a thickness of 1.6 mm.

The first partial region X has an upper edge 5 that, starting from the engine edge M, is arranged offset in the direction of the roof edge D. The upper edge 5 of the first partial region X runs between the side edges K, wherein the defect areas 4 are introduced between the upper edge 5 of the first partial region X and the engine edge M. In the present case, defect areas 4 are arranged on the interior-side surface IV of the inner pane 2. This has proven to be particularly advantageous for achieving early fracture of the windshield 10 in the head impact test. Further improved results can be achieved if, as shown in FIG. 2, defect areas 4 are additionally arranged on the interior-side surface II of the outer pane 1.

The inventors have carried out tests that experimentally confirm a targeted weakening of a glass pane in the region of a defect area 4 introduced by means of indentation. For this purpose, the inventors carried out tests with float glass panes having a thickness of 1.6 mm and 2.1 mm. A series of such samples were provided with defect areas 4, wherein the indentation load was varied. Glass produced in float glass methods has different surface characteristics and stresses on the opposite surfaces of the float glass pane. A distinction is made between the so-called tin side, also referred to as bath side, of the float glass pane, which refers to the glass surface that was in contact with the tin bath, and the so-called air side (also referred to as fire side or atmosphere side), which refers to the remaining opposite glass surface. FIGS. 3a and 3b show defect areas 4 introduced by indentation on the fire side of two samples. The sample shown in FIG. 3a is a glass pane 6 consisting of float glass having a thickness of 2.1 mm, wherein indentation was carried out using a Vickers tip according to DIN EN ISO 6507-1:2018 to-4:2018 with an indentation load of 250 g on the air side of the sample. This applies analogously to the sample in FIG. 3b with the difference that indentation was carried out with an indentation load of 500 g. A schematic representation of the device used to indent the samples is shown in FIG. 5. A force sensor 11 is attached to a holding device 15. The force sensor 11 holds a system 12 for adjusting the height of the indenter tip and the indenter tip 14. The indenter tip 14 is first positioned over the region of the sample 6 to be indented, with the indenter tip 14 being held in the air by the force sensor 11. The height adjustment system 12 comprises a plate 13, by the weight of which the indentation load can be adjusted.

The samples of FIGS. 3a, 3b as well as other samples indented using the same method with different indentation loads were subjected to a bending strength test according to DIN EN 1288-5. The diagram in FIG. 4 shows the bending strength of a series of samples as a function of the indentation load during indentation using a Vickers tip according to DIN EN ISO 6507-1:2018 to-4:2018. No systematic fracture occurred in the region of the indentation impression at an indentation load of 100 g. Therefore, when using a Vickers tip, indentation loads greater than 100 g are preferred. As can be seen in the diagram, a significant reduction in bending strength can be observed with increasing indentation load. This is also to be expected on impact of a pedestrian in the first partial region X of a vehicle composite pane 10 having defect areas 4. Defect areas introduced with an indentation load of 250 g to 500 g have proven to be particularly advantageous in order to make them as visually inconspicuous as possible and to ensure good stone impact resistance of the pane.

### LIST OF REFERENCE SIGNS

10 Windshield
1 Outer pane
2 Inner pane
3 Thermoplastic intermediate layer
4 Defect areas
5 Upper edge of the first partial region X
6 Glass pane, sample
11 Force sensor
12 Indenter tip height adjustment system
13 Plate for adjusting the indentation load
14 Indenter tip
15 Holding device
X First partial region
Y Second partial region
D Roof edge
M Engine edge
S Side edges
Z Section shown in large detail
CC′ Cutting line
I Outer surface of the outer pane 1
II Interior-side surface of the outer pane 1
III Outer surface of the inner pane 2
IV Interior-side surface of the inner pane 2

1. A method for producing a vehicle composite pane with improved impact protection, the method comprising:
a) providing an outer pane made of glass and an inner pane made of glass
b) introducing in at least a first partial region defect areas into the outer pane and/or inner pane,
c) bending the outer pane with defect areas and/or the inner pane with defect areas,
d) placing a thermoplastic intermediate layer onto the outer pane or the inner pane,
e) completing the layer stack with the inner pane or outer pane, and
f) laminating the layer stack composed of at least the outer pane, thermoplastic intermediate layer and inner pane to form a windshield,
wherein the defect areas are introduced into the outer pane and/or inner pane by means of indentation.

2. The method according to claim 1, wherein the defect areas are introduced to the interior-side surface of the outer pane and/or to the interior-side surface of the inner pane.

3. The method according to claim 1, wherein the defect areas are spherical, rectangular, rhombic, pyramidal or conical and are introduced by means of microindentation or nanoindentation.

4. The method according to claim 1, wherein the defect areas are introduced by indentation with an indenter tip for hardness testing according to Brinell according to DIN EN ISO 6506-1 to EN ISO 6506-4, Vickers according to DIN EN ISO 6507-1:2018 to −4:2018, Knoop according to DIN EN ISO 4545-1 to −4,Rockwell according to DIN EN ISO 6508-1, or with an indenter tip having the basic shape of a triangular pyramid according to Berkovich.

5. The method according to claim 4, wherein the defect areas are introduced by indentation with an indenter tip for hardness testing according to Vickers with an indentation load of 50 g to 700 g.

6. The method according to claim 1, wherein indentation in step b) is carried out by means of several indenter tips which contact the surface to be indented at least partially simultaneously.

7. The method according to claim 1, wherein the outer pane and/or the inner pane are bent in step c) at a temperature of 500° C. to 700° C.

8. A vehicle composite pane comprising an outer pane made of glass with an outer surface and an interior-side surface and an inner pane made of glass with an outer surface and an interior-side surface, wherein the interior-side surface of the outer pane and the outer surface of the inner pane are connected to one another via a thermoplastic intermediate layer, and wherein
the vehicle composite pane comprises, in at least a first partial region, defect areas which are introduced into the outer pane and/or inner pane, and
the defect areas are introduced into the outer pane and/or inner pane by means of indentation.

9. The vehicle composite pane according to claim 8, wherein the defect areas are introduced into the interior-side surface of the outer pane or the interior-side surface of the inner pane.

10. The vehicle composite pane according to claim 8, wherein the defect areas form a regular or irregular pattern and mutually adjacent defect areas have an average distance of 1 cm to 50 cm from one another.

11. The vehicle composite pane according to claim 8, wherein the first partial region takes up a proportion of 10% to 100%; of a total area of the vehicle composite pane.

12. The vehicle composite pane according to claim 8, wherein the vehicle pane is a windshield comprising an engine edge, a roof edge and two side edges running between them, and the first partial region extends at least in sections starting from the engine edge by an amount in the direction of the roof edge which corresponds to 10% to 90% of a height of the windshield.

13. The vehicle composite pane according to claim 8, wherein the thermoplastic intermediate layer comprises polyvinyl butyral (PVB), polyurethane (PU), ionomers and/or ethylene vinyl acetate (EVA).

14. The vehicle composite pane according to claim 8, wherein the outer pane and the inner pane comprise glass and each have a thickness of 0.8 mm to 2.5 mm.

15. A vehicle comprising a vehicle composite pane according to claim 8, wherein a size of the first partial region is selected such that the size of the first partial region corresponds to at least 90% of the area of the projection of the dashboard of the motor vehicle onto the windshield.

16. The method according to claim 5, wherein the indentation load is from 100 g to 600 g.

17. The vehicle composite pane according to claim 10, wherein the average distance is from 2 cm to 30 cm.

18. The vehicle composite pane according to claim 11, wherein the first partial region takes up a proportion of 20% to 90% of the total area of the vehicle composite pane.

19. The vehicle composite pane according to claim 12, wherein the first partial region extends at least in sections starting from the engine edge by an amount in the direction of the roof edge which corresponds to 20% to 70% of the height of the windshield.

20. The vehicle composite pane according to claim 14, wherein the thickness is from 1.2 mm to 2.2 mm.
